(19) United States
(12) Patent Application Publication
(10) Pub. No.: US 2025/0105611 A1
(43) Pub. Date: Mar. 27, 2025

(54) ELECTRICAL CONNECTION BOX

(71) Applicants: YAZAKI CORPORATION, Tokyo (JP); TOYOTA JIDOSHA KABUSHIKI KAISHA, Aichi-ken (JP)

(72) Inventors: Yoshitake Mitsuhashi, Kakegawa-shi (JP); Jo Naito, Kakegawa-shi (JP); Nobuyuki Oka, Kakegawa-shi (JP); Kozue Yorifuji, Fuji-shi (JP); Akinori Goto, Sunto-gun (JP); Satoru Ishikawa, Sunto-gun (JP)

(21) Appl. No.: 18/887,022

(22) Filed: Sep. 16, 2024

(30) Foreign Application Priority Data
Sep. 21, 2023 (JP) 2023-154108

(51) Int. Cl. H02G 5/08; H02G 3/08

(52) U.S. Cl. CPC H02G 5/08; H02G 3/081

(57) ABSTRACT

An electrical connection box includes: a bus bar that includes a bus bar base portion having a flat plate shape and a bus bar terminal connection portion having a male tab shape erected from the bus bar base portion; a relay component in which a relay terminal connection portion is provided; a relay terminal fitting that physically and electrically connects the bus bar terminal connection portion and physically and electrically connects the relay terminal connection portion; and a housing that houses the bus bar, the relay component, and the relay terminal fitting.

### CROSS-REFERENCE TO RELATED APPLICATION(S)

The present application claims priority to and incorporates by reference the entire contents of Japanese Patent Application No. 2023-154108 filed in Japan on Sep. 21, 2023.

### BACKGROUND OF THE INVENTION

### 1. Field of the Invention

The present invention relates to an electrical connection box.

### 2. Description of the Related Art

A bus bar is housed in a housing of an electrical connection box such as a junction box, and electrically connects at least two electrical connection target components. The bus bar is, for example, a plate-like conductive member press-molded using a metal plate as a base material, and includes a terminal connection portion formed in a male tab shape to which the electrical connection target component is directly or indirectly connected. An electrical connection box including this type of bus bar is disclosed in Japanese Patent Application Laid-open No. 2010-259228.

Meanwhile, in a case where the electrical connection target component is a relay component that can be an excitation source, vibration accompanying driving of the relay component is transmitted to the terminal connection portion of the bus bar, and the vibration is propagated from the terminal connection portion as a starting point. The bus bar is housed in the housing of the electrical connection box with a certain degree of play (slack), which may lead to abnormal noise caused by vibration of the bus bar. The bus bar may be electrically connected to the relay component via a relay terminal fitting. In this case, the relay terminal fitting indirectly connects the male tab-shaped terminal connection portion of the bus bar to a male tab-shaped terminal connection portion of the relay component. Here, when the relay terminal fitting physically and electrically connects the terminal connection portions by using a spring force, it is desirable that the relay terminal fitting absorbs and damps the vibration accompanying the driving of the relay component. However, the vibration may be amplified by the relay terminal fitting and transmitted to the terminal connection portion of the bus bar.

### SUMMARY OF THE INVENTION

Therefore, an object of the present invention is to provide an electrical connection box capable of suppressing vibration of a bus bar.

An electrical connection box according to one aspect of the present invention includes a bus bar that includes a bus bar base portion having a flat plate shape and a bus bar terminal connection portion having a male tab shape erected from the bus bar base portion; a relay component in which a relay terminal connection portion is provided; a relay terminal fitting that physically and electrically connects the bus bar terminal connection portion and physically and electrically connects the relay terminal connection portion; and a housing that houses the bus bar, the relay component, and the relay terminal fitting, wherein the housing includes a case member in which a bus bar housing chamber that houses the bus bar is formed, and a cover member that covers the bus bar and the case member, and a fixing structure that suppresses vibration of the bus bar base portion when vibration accompanying driving of the relay component is propagated to the bus bar base portion via the bus bar terminal connection portion is provided at least at one position between the bus bar base portion and the case member by inserting one of the bus bar base portion and the case member into the other and fixing the bus bar base portion and the case member to each other.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exploded perspective view for describing an electrical connection box of an embodiment;

FIG. 2 is a perspective view for describing the electrical connection box of the embodiment;

FIG. 3 is a plan view illustrating a bus bar and a relay terminal fitting housed in a bus bar housing chamber;

FIG. 4 is a cross-sectional view of the periphery of the relay terminal fitting in a cross section taken along line X1-X1 of FIG. 2;

FIG. 5 is a plan view illustrating a fixing structure of the embodiment;

FIG. 6 is a perspective view illustrating the bus bar in which a press-fitting portion of the embodiment is provided;

FIG. 7 is a plan view illustrating a part of a bottom wall of the bus bar housing chamber including a press-fitting hole of the embodiment;

FIG. 8 is a view illustrating a part of a cross section taken along line Y-Y of FIG. 5 rotated by 90 degrees, and illustrates a press-fitting state of the press-fitting portion into the press-fitting hole;

FIG. 9 is a diagram illustrating a simulation analysis result of an equivalent radiation power level related to the bus bar of the electrical connection box in which the fixing structure of the embodiment is provided;

FIG. 10 is a plan view illustrating a fixing structure of a first modified example;

FIG. 11 is a view illustrating a part of a cross section taken along line X2-X2 of FIG. 10, and illustrates a press-fitting state of a press-fitting portion into a press-fitting hole;

FIG. 12 is a diagram illustrating a simulation analysis result of an equivalent radiation power level related to the bus bar of an electrical connection box in which the fixing structure of the first modified example is provided;

FIG. 13 is a plan view of a fixing structure of a second modified example when viewed from a bus bar base portion side;

FIG. 14 is a plan view of the fixing structure of the second modified example when viewed from a distal end side of a press-fitting portion;

FIG. 15 is a perspective view illustrating a bus bar in which the press-fitting portion of the second modified example is provided;

FIG. 16 is a perspective view illustrating a part of a bottom wall of a bus bar housing chamber including a press-fitting hole of the second modified example;

FIG. 17 is a diagram illustrating a simulation analysis result of an equivalent radiation power level related to the bus bar of an electrical connection box in which the fixing structure of the second modified example is provided;

FIG. 18 is a plan view of a fixing structure of a third modified example when viewed from a bus bar base portion side;

FIG. 19 is a plan view of the fixing structure of the third modified example when viewed from a distal end side of a spring insertion portion;

FIG. 20 is a perspective view illustrating a bus bar in which the spring insertion portion of the third modified example is provided;

FIG. 21 is a perspective view illustrating a part of a bottom wall of a bus bar housing chamber having an insertion hole of the third modified example;

FIG. 22 is a diagram illustrating a simulation analysis result of an equivalent radiation power level related to the bus bar of an electrical connection box in which the fixing structure of the third modified example is provided;

FIG. 23 is a plan view illustrating a fixing structure of a fourth modified example;

FIG. 24 is a perspective view illustrating a bus bar in which a hook portion of the fourth modified example is provided;

FIG. 25 is a plan view illustrating a part of a bottom wall of a bus bar housing chamber including an insertion-through hole of the fourth modified example;

FIG. 26 is a view illustrating a part of a cross section taken along line X3-X3 of FIG. 23, and illustrates an insertion-through state of the hook portion into the insertion-through hole; and

FIG. 27 is a diagram illustrating a simulation analysis result of an equivalent radiation power level related to the bus bar of an electrical connection box in which the fixing structure of the fourth modified example is provided.

### DETAILED DESCRIPTION OF THE PREFERRED EMBODIMENTS

Hereinafter, an embodiment of an electrical connection box according to the present invention will be described in detail with reference to the drawings. Note that the present invention is not limited by the embodiment.

### Embodiment

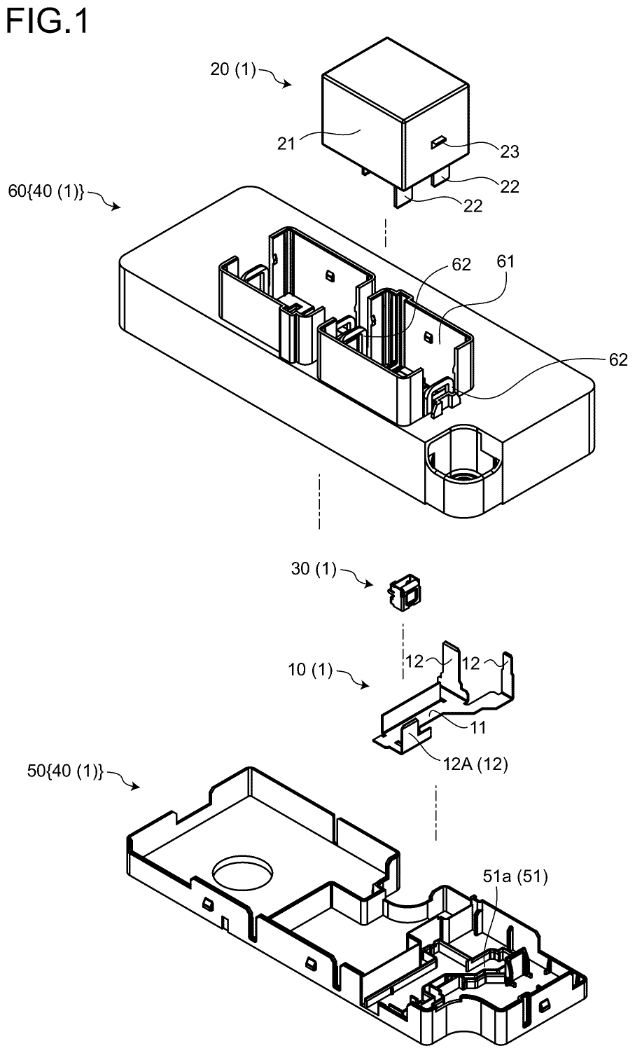

One embodiment of an electrical connection box according to the present invention will be described with reference to FIGS. 1 to 9.

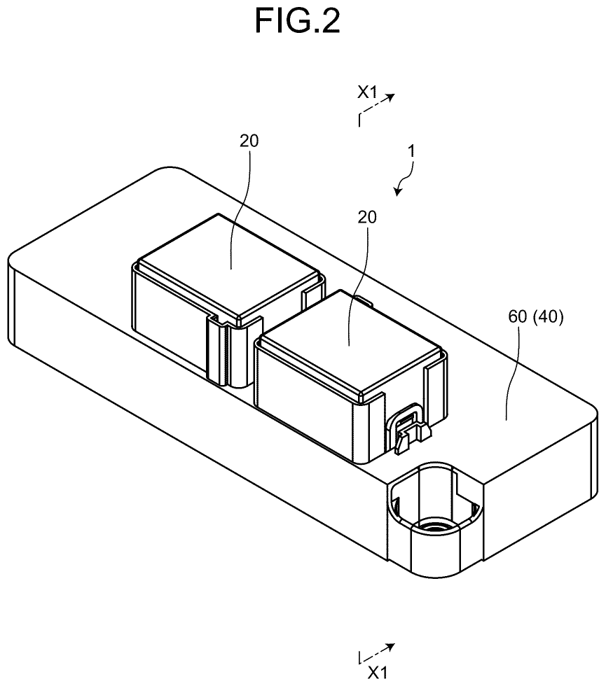

Reference Numeral 1 illustrated in FIG. 1 indicates an electrical connection box of the present embodiment. The electrical connection box 1 is referred to as a junction box or the like, and electrically connects at least two electrical connection target components. The electrical connection box 1 includes a bus bar 10, a relay component 20 as an electrical connection target component, a relay terminal fitting 30 interposed between the bus bar 10 and the relay component 20, and a housing 40 that houses these components (FIGS. 1 and 2). In the electrical connection box 1, the relay component 20 is electrically connected to another electrical connection target component via the bus bar 10 and the relay terminal fitting 30 (FIG. 1).

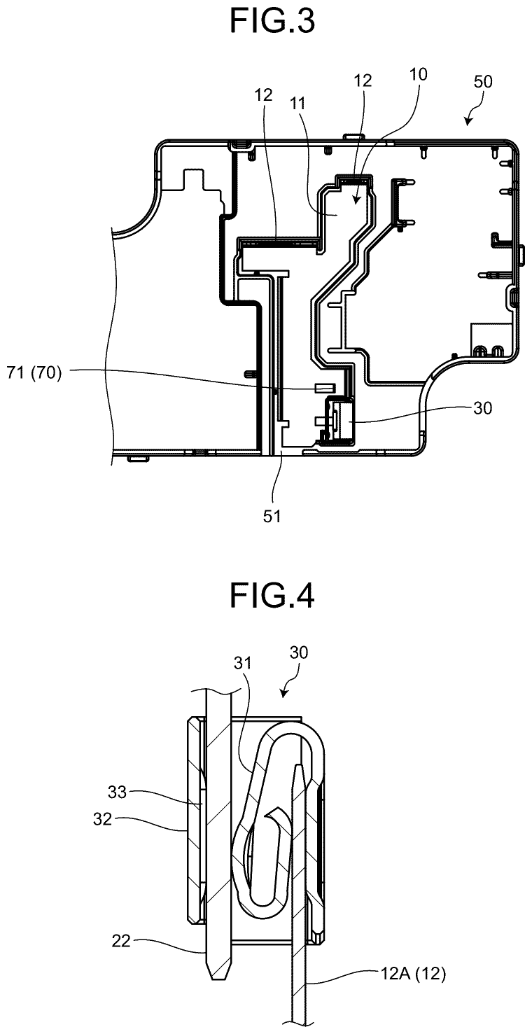

The bus bar 10 is a conductive member formed in a plate shape and formed of a conductive material such as a metal material. For example, the bus bar 10 is press-molded using a metal plate as a base material. The bus bar 10 includes a flat plate-shaped base portion (hereinafter, referred to as a “bus bar base portion”) 11 and a male tab-shaped terminal connection portion (hereinafter, referred to as a “bus bar terminal connection portion”) 12 erected from the bus bar base portion 11 (FIGS. 1 and 3). The bus bar 10 illustrated here includes a plurality of bus bar terminal connection portions 12, and the relay component 20 is electrically connected to one (hereinafter, referred to as a “bus bar terminal connection portion 12A”) of the plurality of bus bar terminal connection portions 12 via the relay terminal fitting 30 (FIGS. 1, 3, and 4).

Here, the relay component 20 includes a relay body 21 and a terminal connection portion (hereinafter, referred to as a “relay terminal connection portion”) 22 protruding from the relay body 21 (FIG. 1). A relay terminal connection portion 22 formed in a male tab shape is provided in the relay component 20 illustrated here.

In addition, the relay terminal fitting 30 includes an electrical connection portion 31 that physically and electrically connects the bus bar terminal connection portion 12A and physically and electrically connects the relay terminal connection portion 22, the electrical connection portion 31 being provided in a cylinder of a cylindrical terminal body 32 (FIG. 4). Therefore, the bus bar terminal connection portion 12A is electrically connected to the relay terminal connection portion 22 via the relay terminal fitting 30. The relay terminal fitting 30 illustrated here is press-molded using a metal plate as a base material.

The electrical connection portion 31 is bent and deformed as the bus bar terminal connection portion 12A is inserted, and a reaction force (spring force) thereof is applied to a flat surface of the bus bar terminal connection portion 12A to clamp the bus bar terminal connection portion 12A between the electrical connection portion 31 and an inner wall surface of the terminal body 32 (FIG. 4). Therefore, the bus bar terminal connection portion 12A is physically and electrically connected to the relay terminal fitting 30 by the spring force of the relay terminal fitting 30 applied to the flat surface. In addition, the electrical connection portion 31 is bent and deformed as the relay terminal connection portion 22 is inserted, and a reaction force (spring force) thereof is applied to a flat surface of the relay terminal connection portion 22 to clamp the relay terminal connection portion 22 between the electrical connection portion 31 and the inner wall surface of the terminal body 32 (FIG. 4). Therefore, the relay terminal connection portion 22 is physically and electrically connected to the relay terminal fitting 30 by the spring force of the relay terminal fitting 30 applied to the flat surface. Here, the relay terminal connection portion 22 is clamped between a bulging portion 33 bulging from the inner wall surface of the terminal body 32 and the electrical connection portion 31. The electrical connection portion 31 illustrated here is formed in a U shape sandwiched between the bus bar terminal connection portion 12A and the relay terminal connection portion 22 in the cylinder of the terminal body 32, and applies the reaction forces (spring forces) in opposite directions to the bus bar terminal connection portion 12A and the relay terminal connection portion 22.

As described above, the electrical connection box 1 includes the housing 40 that houses the bus bar 10, the relay component 20, and the relay terminal fitting 30. The housing 40 includes a case member 50 and a cover member 60 which are formed of an insulating material such as a synthetic resin and are assembled to each other (FIG. 1).

A housing chamber (hereinafter, referred to as a “bus bar housing chamber”) 51 that houses the bus bar 10 is formed in the case member 50 (FIGS. 1 and 3). The bus bar 10 is housed in the bus bar housing chamber 51 in a state in which the relay terminal fitting 30 is assembled to the bus bar terminal connection portion 12A. Therefore, the relay terminal fitting 30 is also housed in the bus bar housing chamber 51.

The cover member 60 covers the bus bar 10 and the case member 50 by being assembled to the case member 50. The cover member 60 illustrated here covers the bus bar 10 and the relay terminal fitting 30. Therefore, the cover member 60 has a through-hole for inserting the relay terminal connection portion 22 into the relay terminal fitting 30. In the cover member 60, a standing wall surrounding the through-hole is provided on an outer wall surface, and a space inside the standing wall is used as a housing chamber (hereinafter, referred to as a “relay housing chamber”) 61 for the relay component 20 (FIG. 1).

A part of the standing wall of the cover member 60 is cut out, and a holding portion (hereinafter, referred to as a “relay holding portion”) 62 that holds the relay component 20 in the relay housing chamber 61 is provided at the cut-out part (FIG. 1). The relay holding portion 62 constitutes a so-called locking mechanism that holds a claw portion 23 by being hooked on the claw portion 23 protruding from an outer wall surface of the relay body 21 (FIG. 1).

In the housing 40, the case member 50 does not include a holding mechanism that holds the bus bar 10 in the bus bar housing chamber 51 (for example, a mechanism in which a through-hole is provided in the bus bar 10, a claw portion to be inserted into the through-hole is provided on a standing wall of the bus bar housing chamber 51, and the claw portion is hooked on a peripheral edge of the through-hole to hold the bus bar 10 in the bus bar housing chamber 51). However, in the housing 40, the bus bar 10 is indirectly held with respect to the cover member 60 via the relay component 20 held by the cover member 60 and the relay terminal fitting 30 to which the relay terminal connection portion 22 of the relay component 20 is fitted and connected.

Meanwhile, in the relay component 20, vibration is caused by an on/off switching operation, and the vibration is transmitted to the relay terminal connection portion 22. The vibration accompanying the driving of the relay component 20 is transmitted from the relay terminal connection portion 22 to the bus bar terminal connection portion 12A via the relay terminal fitting 30, and is transmitted from the bus bar terminal connection portion 12A to the bus bar base portion 11. Since the bus bar 10 is not fixed to the case member 50, when the vibration of the relay component 20 is propagated to the bus bar base portion 11, there is a possibility that abnormal noise occurs due to the vibration of the bus bar base portion 11. In addition, even when the bus bar 10 in the bus bar housing chamber 51 is held by the case member 50 using the holding mechanism described above, the holding mechanism is provided with play (slack) between the claw portion and the through-hole, so that the bus bar 10 can be relatively moved with respect to the case member 50 in the bus bar housing chamber 51 by the degree of play. Therefore, even in a case where the bus bar 10 is held by the case member 50 using the holding mechanism, when the vibration of the relay component 20 is propagated to the bus bar base portion 11, the vibration of the bus bar base portion 11 may cause abnormal noise.

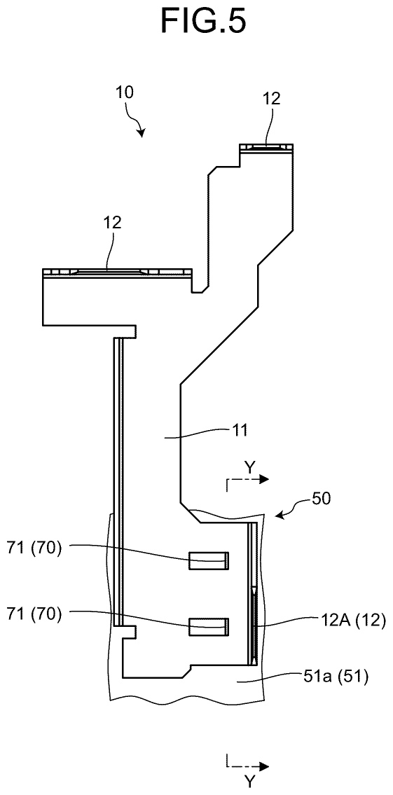

Therefore, in the present embodiment, a fixing structure 70 that suppresses the vibration of the bus bar base portion 11 when the vibration accompanying the driving of the relay component 20 is propagated to the bus bar base portion 11 via the bus bar terminal connection portion 12A is provided at least at one position by inserting one of the bus bar base portion 11 and the case member 50 into the other and fixing the bus bar base portion 11 and the case member 50 to each other (FIGS. 5 to 8).

The fixing structure 70 of the present embodiment is a press-fitting structure including a press-fitting portion 71 erected from the bus bar base portion 11 in a plate thickness direction of the bus bar base portion 11 and a press-fitting hole 72 provided in a bottom wall 51a of the bus bar housing chamber 51 in the case member 50 and into which the press-fitting portion 71 is inserted, press-fitted, and fixed (FIGS. 5 to 8). In the electrical connection box 1, when the vibration accompanying the driving of the relay component 20 is propagated to the bus bar base portion 11 via the bus bar terminal connection portion 12A, the vibration is damped until the vibration is transmitted to the fixing structure 70, and the vibration of the bus bar 10 can be suppressed.

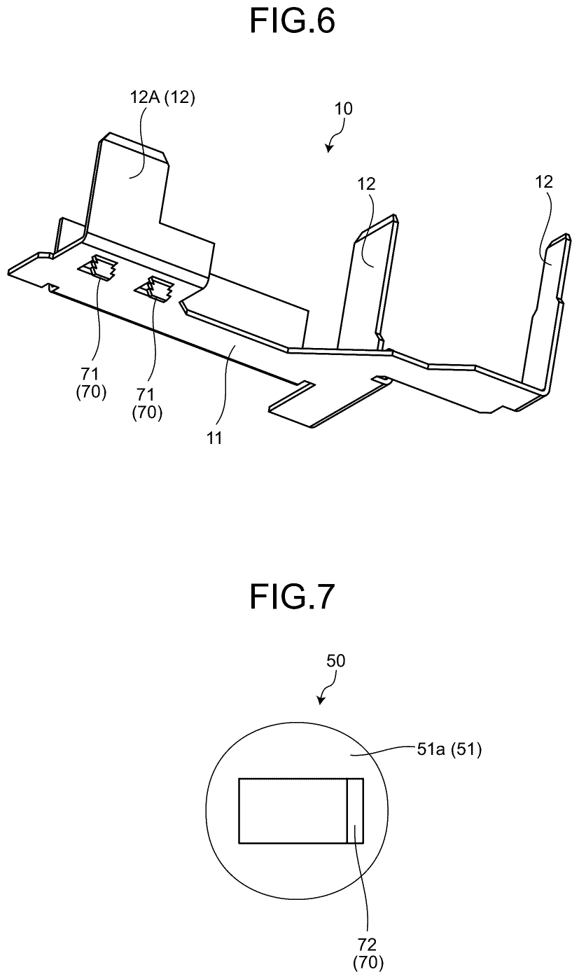

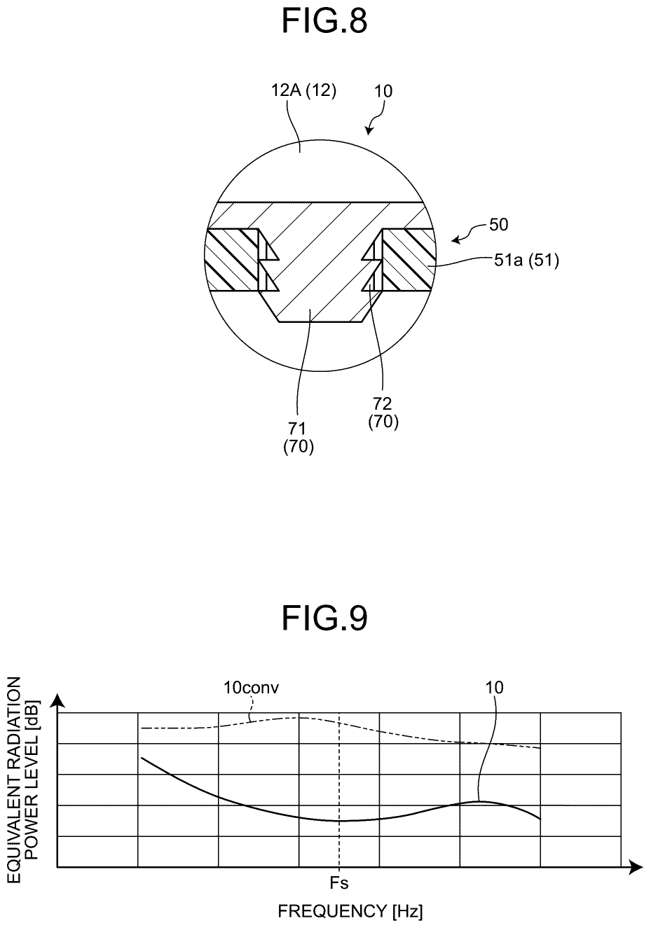

The press-fitting portion 71 is erected from the bus bar base portion 11 in the plate thickness direction of the bus bar base portion 11 toward the bottom wall 51a of the bus bar housing chamber 51 (FIGS. 6 and 8). The press-fitting portion 71 illustrated here is formed in a piece shape in which a plurality of trapezoidal plate-like portions having the same shape with an upper base facing the bottom wall 51a are connected in a press-fitting direction (FIGS. 6 and 8). Here, three plate-like portions are connected. The press-fitting hole 72 is formed as a through-hole penetrating through the bottom wall 51a (FIGS. 7 and 8). The press-fitting hole 72 illustrated here is formed as a rectangular through-hole (FIGS. 7 and 8). The press-fitting portion 71 is press-fitted and fixed to the press-fitting hole 72 while cutting an inner peripheral wall of the press-fitting hole 72 with an inclined side wall connecting the upper base and a lower base of each plate-like portion.

A position where the fixing structure 70 is disposed is determined as follows. Here, an equivalent radiation power level of a bus bar 10conv according to the related art is obtained by simulation analysis (a line with alternating long and two short dashes in FIG. 9). In the bus bar 10conv according to the related art, the fixing structure 70 is not provided, and the relay component 20 is assembled to the bus bar terminal connection portion 12A via the relay terminal fitting 30. A result of the analysis indicates that, in the bus bar 10conv according to the related art, the vibration occurs in the vicinity of the bus bar terminal connection portion 12A (that is, the vicinity of a vibration input portion of the relay component 20 in the bus bar base portion 11) in the bus bar base portion 11. Therefore, in the electrical connection box 1 of the present embodiment, the fixing structure 70 is disposed in the vicinity of the bus bar terminal connection portion 12A (that is, the vicinity of the vibration input portion of the relay component 20 in the bus bar base portion 11) in the bus bar base portion 11. In this example, the fixing structure 70 is provided at a position and in a quantity where the equivalent radiation power level is lowered at a specific frequency (a frequency of the vibration accompanying the driving of the relay component 20) Fs.

In this example, the fixing structure 70 is provided at each of two positions between the bus bar base portion 11 and the case member 50, and the vibration of the bus bar base portion 11 is suppressed at each position where the fixing structure 70 is provided. A solid line in FIG. 9 indicates an equivalent radiation power level of the bus bar 10 in the electrical connection box 1 in which the fixing structure 70 is provided. The equivalent radiation power level of the bus bar 10 at the specific frequency Fs can be lower than that of the bus bar 10conv according to the related art to which the fixing structure 70 is not applied.

As described above, the electrical connection box 1 of the present embodiment can damp the vibration accompanying the driving of the relay component 20 propagated to the bus bar base portion 11 via the bus bar terminal connection portion 12A by fixing the bus bar base portion 11 and the case member 50 using the fixing structure 70 provided between the bus bar base portion 11 and the case member 50. Therefore, the electrical connection box 1 can suppress the vibration of the bus bar 10 and can suppress occurrence of abnormal noise caused by the vibration of the bus bar 10. Further, in the electrical connection box 1, when the relay terminal fitting 30 absorbs and damps the vibration accompanying the driving of the relay component 20, it is possible to suppress the propagation of the vibration to the bus bar base portion 11, so that it is possible to further suppress the occurrence of abnormal noise caused by the vibration of the bus bar 10. On the other hand, in the electrical connection box 1, the fixing structure 70 is provided at an appropriate position, so that it is possible to suppress the vibration of the bus bar 10 and the occurrence of abnormal noise caused by the vibration even when the relay terminal fitting 30 amplifies the vibration accompanying the driving of the relay component 20.

Furthermore, since the electrical connection box 1 of the present embodiment can suppress the vibration of the bus bar 10, it is also possible to suppress abrasion of a contact point between the bus bar terminal connection portion 12A and the relay terminal fitting 30.

### First Modified Example

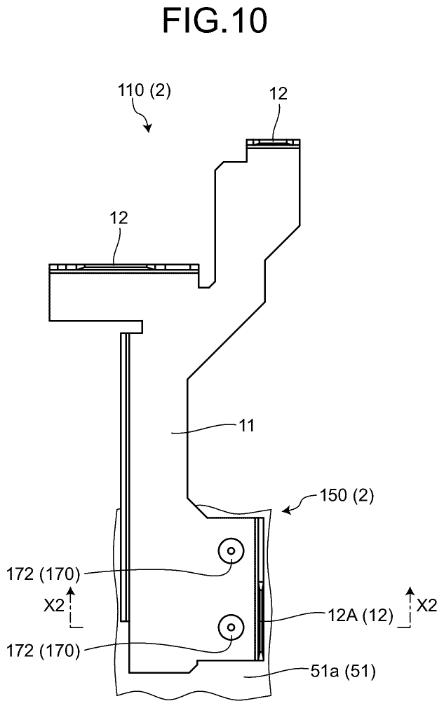

One modified example of the electrical connection box according to the present invention will be described with reference to FIGS. 10 to 12.

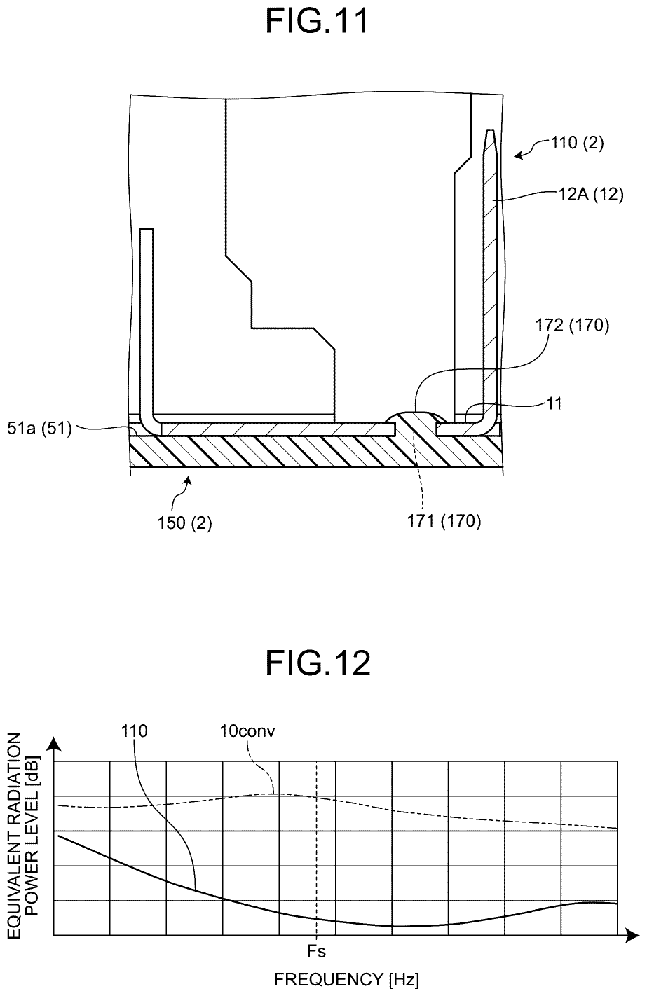

In an electrical connection box 2 of the present modified example, the bus bar 10 and the case member 50 of the housing 40 in the electrical connection box 1 of the embodiment described above are replaced with a bus bar 110 and a case member 150 described below, and the fixing structure 70 of the embodiment provided between the bus bar 10 and the case member 50 is changed to a fixing structure 170 described below (FIGS. 10 and 11). Therefore, in the following description, parts and the like equivalent to those illustrated in the embodiment are denoted by the same reference numerals as those in the embodiment, and a description thereof is omitted.

The bus bar 110 of the present modified example includes a bus bar base portion 11 and a bus bar terminal connection portion 12 similarly to the bus bar 10 of the embodiment (FIG. 10), and electrically connects a relay component 20 to a bus bar terminal connection portion 12A of the plurality of bus bar terminal connection portions 12 via a relay terminal fitting 30. Meanwhile, in the bus bar 110 of the present modified example, a rivet hole 171 described below is provided in the bus bar base portion 11 instead of the press-fitting portion 71 provided in the bus bar base portion 11 of the bus bar 10 of the embodiment (FIG. 11).

The case member 150 of the present modified example includes a bus bar housing chamber 51 similarly to the case member 50 of the embodiment (FIG. 10), and the bus bar 110 and the relay terminal fitting 30 are housed in the bus bar housing chamber 51. Meanwhile, in the case member 150 of the present modified example, a rivet portion 172 described below is provided in a bottom wall 51a instead of the press-fitting hole 72 provided in the bottom wall 51a of the bus bar housing chamber 51 in the case member 50 of the embodiment (FIGS. 10 and 11).

The fixing structure 170 of the present modified example is a riveting structure including the rivet hole 171 having a through-hole shape and provided in the bus bar base portion 11, and the rivet portion 172 that protrudes from the bottom wall 51a of the bus bar housing chamber 51 in the case member 150 so as to be inserted through the rivet hole 171 and fixes the bus bar base portion 11 to the case member 150 at a plastically deformed end portion (FIGS. 10 and 11). In the electrical connection box 2, when vibration accompanying driving of the relay component 20 is propagated to the bus bar base portion 11 via the bus bar terminal connection portion 12A, the vibration is damped until the vibration is transmitted to the fixing structure 170, and the vibration of the bus bar 110 can be suppressed.

The rivet hole 171 is formed as a through-hole penetrating through the bus bar base portion 11 (FIG. 11). The rivet hole 171 illustrated here is formed as a circular through-hole. The rivet portion 172 is erected from the bottom wall 51a of the bus bar housing chamber 51 toward the bus bar base portion 11 in a plate thickness direction (FIG. 11). The rivet portion 172 illustrated here is formed as a cylindrical shaft portion before plastic deformation, and is inserted through the rivet hole 171, and a distal end of the rivet portion 172 is crushed to be plastically deformed (FIGS. 10 and 11). In the fixing structure 170, the bus bar base portion 11 is clamped between the bottom wall 51a and the plastically deformed end portion of the rivet portion 172, and is thus fixed to the case member 150 (FIG. 11).

Similarly to the fixing structure 70 of the embodiment, a position where the fixing structure 170 is disposed is determined based on a simulation analysis result indicating the equivalent radiation power level of the bus bar 10conv according to the related art in which the fixing structure 170 is not provided and the relay component 20 is assembled to the bus bar terminal connection portion 12A via the relay terminal fitting 30 (a line with alternating long and two short dashes in FIG. 12). Therefore, in the electrical connection box 2 of the present modified example, the fixing structure 170 is disposed in the vicinity of the bus bar terminal connection portion 12A (that is, the vicinity of a vibration input portion of the relay component 20 in the bus bar base portion 11) in the bus bar base portion 11.

In this example, the fixing structure 170 is provided at each of two positions between the bus bar base portion 11 and the case member 150, and the vibration of the bus bar base portion 11 is suppressed at each position where the fixing structure 170 is provided. A solid line in FIG. 12 indicates an equivalent radiation power level of the bus bar 110 in the electrical connection box 2 in which the fixing structure 170 is provided. The equivalent radiation power level of the bus bar 110 at the specific frequency Fs can be lower than that of the bus bar 10conv according to the related art to which the fixing structure 170 is not applied.

As described above, the electrical connection box 2 of the present modified example can damp the vibration accompanying the driving of the relay component 20 propagated to the bus bar base portion 11 via the bus bar terminal connection portion 12A by fixing the bus bar base portion 11 and the case member 150 using the fixing structure 170 provided between the bus bar base portion 11 and the case member 150. Therefore, the electrical connection box 2 can suppress the vibration of the bus bar 110 and can suppress occurrence of abnormal noise caused by the vibration of the bus bar 110. Further, in the electrical connection box 2, when the relay terminal fitting 30 absorbs and damps the vibration accompanying the driving of the relay component 20, it is possible to suppress the propagation of the vibration to the bus bar base portion 11, so that it is possible to further suppress the occurrence of abnormal noise caused by the vibration of the bus bar 110. On the other hand, in the electrical connection box 2, the fixing structure 170 is provided at an appropriate position, so that it is possible to suppress the vibration of the bus bar 110 and the occurrence of abnormal noise caused by the vibration even when the relay terminal fitting 30 amplifies the vibration accompanying the driving of the relay component 20.

Furthermore, since the electrical connection box 2 of the present modified example can suppress the vibration of the bus bar 110, it is also possible to suppress abrasion of a contact point between the bus bar terminal connection portion 12A and the relay terminal fitting 30.

### Second Modified Example

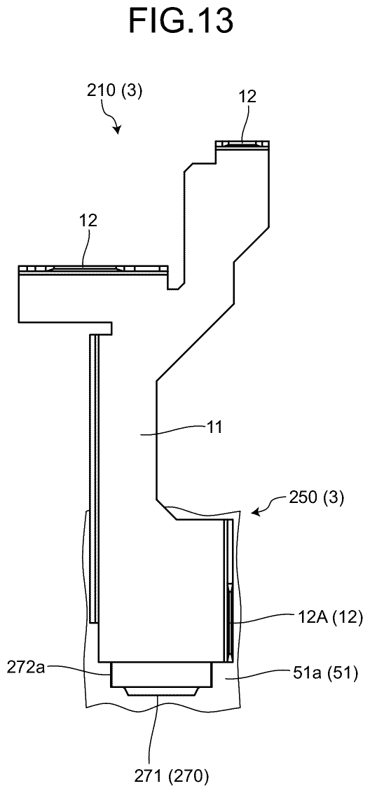

One modified example of the electrical connection box according to the present invention will be described with reference to FIGS. 13 to 17.

In an electrical connection box 3 of the present modified example, the bus bar 10 and the case member 50 of the housing 40 in the electrical connection box 1 of the embodiment described above are replaced with a bus bar 210 and a case member 250 described below, and the fixing structure 70 of the embodiment provided between the bus bar 10 and the case member 50 is changed to a fixing structure 270 described below (FIGS. 13 to 16). Therefore, in the following description, parts and the like equivalent to those illustrated in the embodiment are denoted by the same reference numerals as those in the embodiment, and a description thereof is omitted.

The bus bar 210 of the present modified example includes a bus bar base portion 11 and a bus bar terminal connection portion 12 similarly to the bus bar 10 of the embodiment (FIGS. 13 to 15), and electrically connects a relay component 20 to a bus bar terminal connection portion 12A of the plurality of bus bar terminal connection portions 12 via a relay terminal fitting 30. On the other hand, in the bus bar 210 of the present modified example, a press-fitting portion 271 described below is provided in the bus bar base portion 11 instead of the press-fitting portion 71 provided in the bus bar base portion 11 of the bus bar 10 of the embodiment (FIGS. 13 to 15).

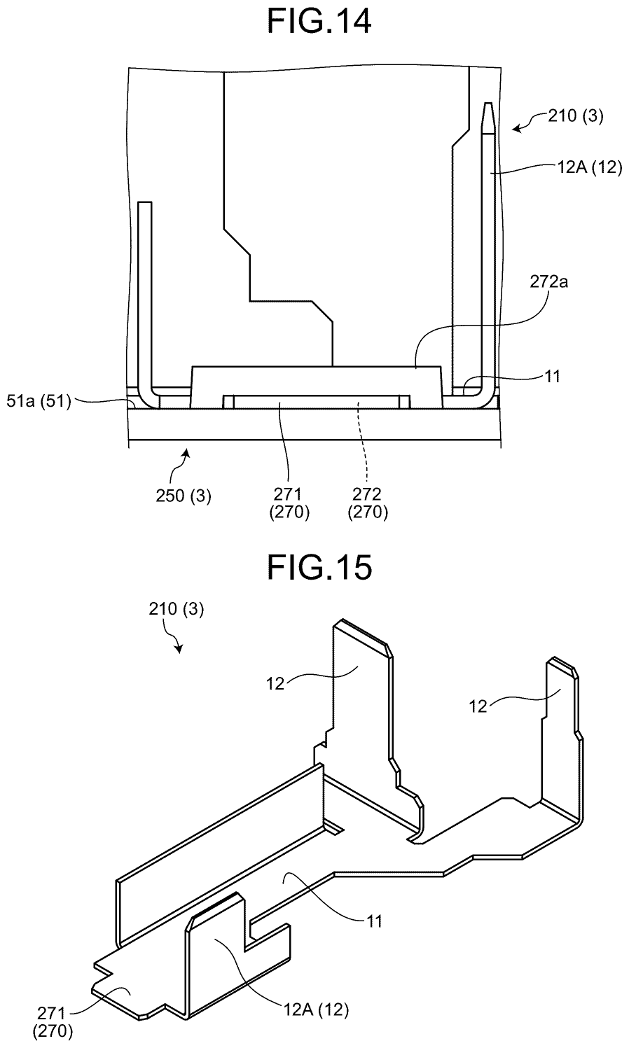

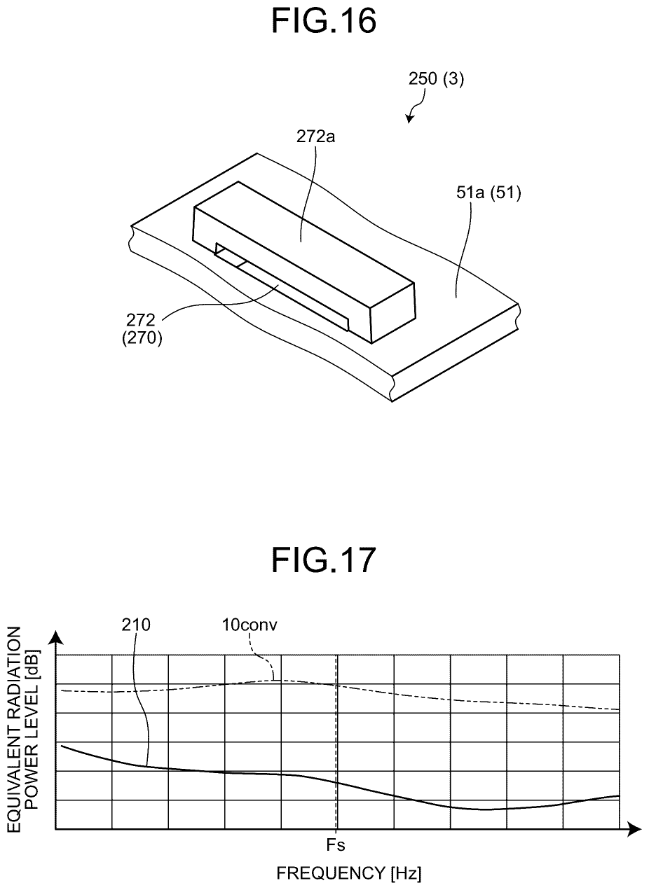

The case member 250 of the present modified example includes a bus bar housing chamber 51 similarly to the case member 50 of the embodiment (FIGS. 13, 14, and 16), and the bus bar 210 and the relay terminal fitting 30 are housed in the bus bar housing chamber 51. Meanwhile, in the case member 250 of the present modified example, a press-fitting hole 272 described below is provided in a bottom wall 51a instead of the press-fitting hole 72 provided in the bottom wall 51a of the bus bar housing chamber 51 in the case member 50 of the embodiment (FIGS. 14 and 16).

The fixing structure 270 of the present modified example is a slide press-fitting structure including the press-fitting portion 271 protruding from the bus bar base portion 11 along a flat surface of the bus bar base portion 11, and the press-fitting hole 272 provided in the case member 250 and into which the press-fitting portion 271 is slidably inserted in a protruding direction of the press-fitting portion 271 to be press-fitted (FIGS. 13 to 16). In the electrical connection box 3, when vibration accompanying driving of the relay component 20 is propagated to the bus bar base portion 11 via the bus bar terminal connection portion 12A, the vibration is damped until the vibration is transmitted to the fixing structure 270, and the vibration of the bus bar 210 can be suppressed.

The press-fitting portion 271 protrudes from a part of an outer peripheral edge of the bus bar base portion 11 along the flat surface of the bus bar base portion 11 (FIG. 15). The press-fitting portion 271 illustrated here is formed in a rectangular piece shape on the same plane as the bus bar base portion 11 (FIG. 15). The press-fitting hole 272 is provided in a bulging portion 272a bulging from the flat plate-shaped bottom wall 51a toward the bus bar base portion 11 (FIGS. 14 and 16). The bulging portion 272a illustrated here is formed in a rectangular parallelepiped shape in which two wall surfaces are orthogonal to a direction in which the press-fitting portion 271 is slidably inserted and the remaining four wall surfaces are parallel to the direction in which the press-fitting portion 271 is slidably inserted (FIG. 16). In the bulging portion 272a, a rectangular through-hole that is hollowed along the flat surface of the bus bar base portion 11 in the direction in which the press-fitting portion 271 is slidably inserted is used as the press-fitting hole 272.

When the bus bar 210 of the present modified example is housed in the bus bar housing chamber 51, for example, the press-fitting portion 271 is shifted from the bulging portion 272a, and the bus bar base portion 11 is placed on the bottom wall 51a of the bus bar housing chamber 51. Then, the press-fitting portion 271 of the bus bar 210 is inserted into the press-fitting hole 272 while sliding the bus bar base portion 11 along the bottom wall 51a in the direction in which the press-fitting portion 271 is slidably inserted. Accordingly, the press-fitting portion 271 is press-fitted and fixed to the press-fitting hole 272.

Similarly to the fixing structure 70 of the embodiment, a position where the fixing structure 270 is disposed is determined based on a simulation analysis result indicating the equivalent radiation power level of the bus bar 10conv according to the related art in which the fixing structure 270 is not provided and the relay component 20 is assembled to the bus bar terminal connection portion 12A via the relay terminal fitting 30 (a line with alternating long and two short dashes in FIG. 17). Therefore, in the electrical connection box 3 of the present modified example, the fixing structure 270 is disposed in the vicinity of the bus bar terminal connection portion 12A (that is, the vicinity of a vibration input portion of the relay component 20 in the bus bar base portion 11) in the bus bar base portion 11. In this example, the fixing structure 270 is provided at one position between the bus bar base portion 11 and the case member 250, and the vibration of the bus bar base portion 11 is suppressed at each position where the fixing structure 270 is provided. A solid line in FIG. 17 indicates an equivalent radiation power level of the bus bar 210 in the electrical connection box 3 in which the fixing structure 270 is provided. The equivalent radiation power level of the bus bar 210 at the specific frequency Fs can be lower than that of the bus bar 10conv according to the related art to which the fixing structure 270 is not applied.

As described above, the electrical connection box 3 of the present modified example can damp the vibration accompanying the driving of the relay component 20 propagated to the bus bar base portion 11 via the bus bar terminal connection portion 12A by fixing the bus bar base portion 11 and the case member 250 using the fixing structure 270 provided between the bus bar base portion 11 and the case member 250. Therefore, the electrical connection box 3 can suppress the vibration of the bus bar 210 and can suppress occurrence of abnormal noise caused by the vibration of the bus bar 210. Further, in the electrical connection box 3, when the relay terminal fitting 30 absorbs and damps the vibration accompanying the driving of the relay component 20, it is possible to suppress the propagation of the vibration to the bus bar base portion 11, so that it is possible to further suppress the occurrence of abnormal noise caused by the vibration of the bus bar 210. On the other hand, in the electrical connection box 3, the fixing structure 270 is provided at an appropriate position, so that it is possible to suppress the vibration of the bus bar 210 and the occurrence of abnormal noise caused by the vibration even when the relay terminal fitting 30 amplifies the vibration accompanying the driving of the relay component 20.

Furthermore, since the electrical connection box 3 of the present modified example can suppress the vibration of the bus bar 210, it is also possible to suppress abrasion of a contact point between the bus bar terminal connection portion 12A and the relay terminal fitting 30.

### Third Modified Example

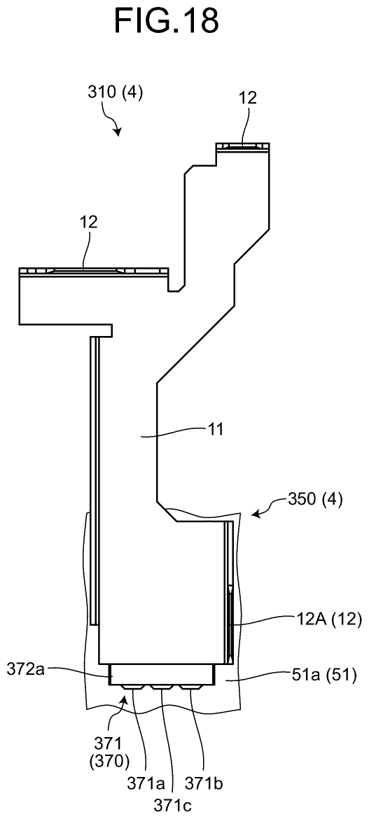

One modified example of the electrical connection box according to the present invention will be described with reference to FIGS. 18 to 22.

In an electrical connection box 4 of the present modified example, the bus bar 10 and the case member 50 of the housing 40 in the electrical connection box 1 of the embodiment described above are replaced with a bus bar 310 and a case member 350 described below, and the fixing structure 70 of the embodiment provided between the bus bar 10 and the case member 50 is changed to a fixing structure 370 described below (FIGS. 18 to 21). Therefore, in the following description, parts and the like equivalent to those illustrated in the embodiment are denoted by the same reference numerals as those in the embodiment, and a description thereof is omitted.

The bus bar 310 of the present modified example includes a bus bar base portion 11 and a bus bar terminal connection portion 12 similarly to the bus bar 10 of the embodiment (FIGS. 18 to 20), and electrically connects a relay component 20 to a bus bar terminal connection portion 12A of the plurality of bus bar terminal connection portions 12 via a relay terminal fitting 30. On the other hand, in the bus bar 310 of the present modified example, a spring insertion portion 371 described below is provided in the bus bar base portion 11 instead of the press-fitting portion 71 provided in the bus bar base portion 11 of the bus bar 10 of the embodiment (FIGS. 18 to 20).

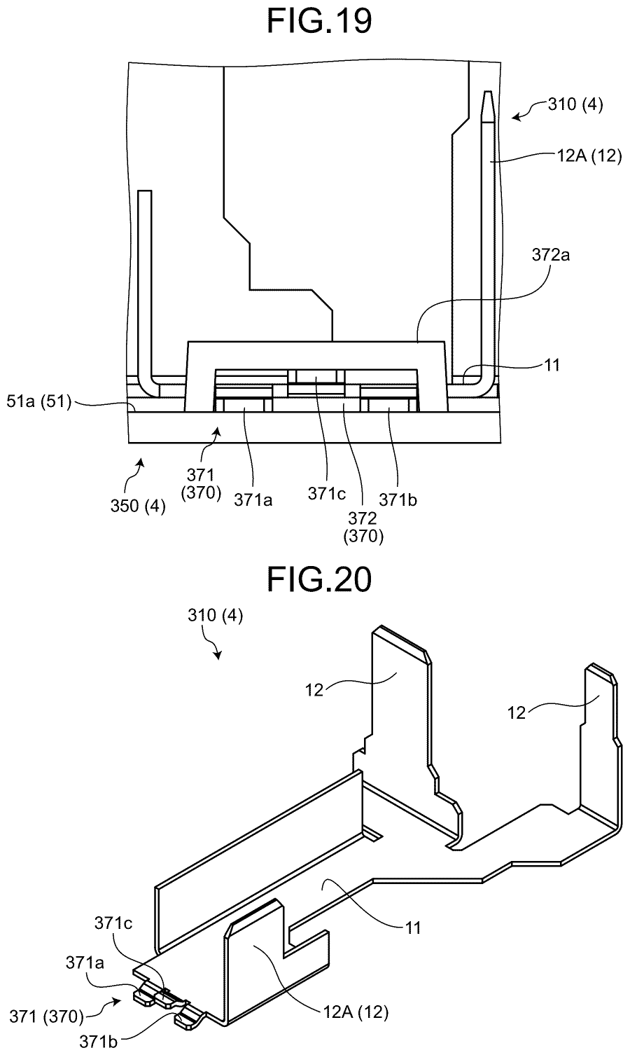

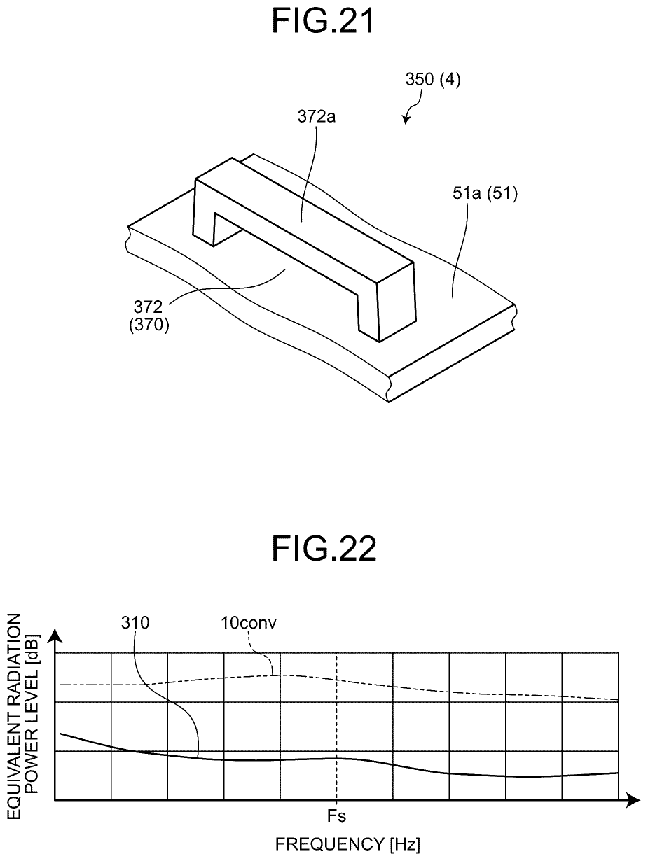

The case member 350 of the present modified example includes a bus bar housing chamber 51 similarly to the case member 50 of the embodiment (FIGS. 18, 19, and 21), and the bus bar 310 and the relay terminal fitting 30 are housed in the bus bar housing chamber 51. Meanwhile, in the case member 350 of the present modified example, an insertion hole 372 described below is provided in a bottom wall 51a instead of the press-fitting hole 72 provided in the bottom wall 51a of the bus bar housing chamber 51 in the case member 50 of the embodiment (FIGS. 19 and 21).

The fixing structure 370 of the present modified example is a spring holding structure including the flexible spring insertion portion 371 that protrudes from the bus bar base portion 11, and the insertion hole 372 that is provided in the case member 350 and holds the spring insertion portion 371 by an inner peripheral wall receiving a spring force from the inserted spring insertion portion 371 after bending deformation (FIGS. 18 to 21). In the electrical connection box 4, when vibration accompanying driving of the relay component 20 is propagated to the bus bar base portion 11 via the bus bar terminal connection portion 12A, the vibration is damped by the fixing structure 370 to suppress the vibration of the bus bar 310.

The spring insertion portion 371 includes a plurality of flexible cantilever portions having a crank shape, the cantilever portions being bent in a direction intersecting a flat surface of the bus bar base portion 11 at middle portions in a protruding direction and bent again at distal ends (FIGS. 18 to 20). In the plurality of cantilever portions, at least one of the cantilever portions is bent toward the bottom wall 51a in the direction intersecting the flat surface of the bus bar base portion 11, and at least one of the remaining cantilever portions is bent toward a side opposite to the bottom wall 51a in the direction intersecting the flat surface of the bus bar base portion 11 (FIG. 20). The spring insertion portion 371 illustrated here includes a first cantilever portion 371a having a piece shape and a second cantilever portion 371b having a piece shape, the first and second cantilever portions 371a and 371b being disposed at an interval in a direction orthogonal to the flat surface of the bus bar base portion 11 and a direction orthogonal to an insertion direction into the insertion hole 372 and being bent toward the bottom wall 51a, and a third cantilever portion 371c having a piece shape, disposed between the first cantilever portion 371a and the second cantilever portion 371b, and bent toward a side opposite to the bottom wall 51a (FIGS. 18 to 20).

The insertion hole 372 is provided in a bulging portion 372a bulging from the flat plate-shaped bottom wall 51a toward the bus bar base portion 11 (FIGS. 19 and 21). The bulging portion 372a illustrated here is formed in a rectangular parallelepiped shape in which two wall surfaces are orthogonal to the insertion direction of the spring insertion portion 371 and the remaining four wall surfaces are parallel to the insertion direction of the spring insertion portion 371 (FIG. 21). In the bulging portion 372a, a rectangular through-hole which is hollowed along the flat surface of the bus bar base portion 11 in the insertion direction of the spring insertion portion 371 is used as the insertion hole 372.

When the bus bar 310 of the present modified example is housed in the bus bar housing chamber 51, for example, the spring insertion portion 371 is shifted from the bulging portion 372a, and the spring insertion portion 371 is inserted into the insertion hole 372 while sliding the bus bar base portion 11 along the bottom wall 51a in the insertion direction of the spring insertion portion 371. In the spring insertion portion 371, after the insertion, free ends of the first cantilever portion 371a and the second cantilever portion 371b are bent and deformed by being pushed by the inner peripheral wall (here, the bottom wall 51a) of the insertion hole 372, and a free end of the third cantilever portion 371c is bent and deformed by being pushed by the inner peripheral wall (here, a wall of the bulging portion 372a facing the bottom wall 51a) of the insertion hole 372. Therefore, in the fixing structure 370 of the present modified example, the spring force of each of the first cantilever portion 371a and the second cantilever portion 371b and the spring force of the third cantilever portion 371c are applied to the inner peripheral wall of the insertion hole 372, whereby the spring insertion portion 371 is press-fitted and fixed to the insertion hole 372.

Similarly to the fixing structure 70 of the embodiment, a position where the fixing structure 370 is disposed is determined based on a simulation analysis result indicating the equivalent radiation power level of the bus bar 10conv according to the related art in which the fixing structure 370 is not provided and the relay component 20 is assembled to the bus bar terminal connection portion 12A via the relay terminal fitting 30 (a line with alternating long and two short dashes in FIG. 22). Therefore, in the electrical connection box 4 of the present modified example, the fixing structure 370 is disposed in the vicinity of the bus bar terminal connection portion 12A (that is, the vicinity of a vibration input portion of the relay component 20 in the bus bar base portion 11) in the bus bar base portion 11.

In this example, the fixing structure 370 is provided at one position between the bus bar base portion 11 and the case member 350, and the vibration of the bus bar base portion 11 is suppressed at each position where the fixing structure 370 is provided. A solid line in FIG. 22 indicates an equivalent radiation power level of the bus bar 310 in the electrical connection box 4 in which the fixing structure 370 is provided. The equivalent radiation power level of the bus bar 310 at the specific frequency Fs can be lower than that of the bus bar 10conv according to the related art to which the fixing structure 370 is not applied.

As described above, the electrical connection box 4 of the present modified example can damp the vibration accompanying the driving of the relay component 20 propagated to the bus bar base portion 11 via the bus bar terminal connection portion 12A by fixing the bus bar base portion 11 and the case member 350 using the fixing structure 370 provided between the bus bar base portion 11 and the case member 350. Therefore, the electrical connection box 4 can suppress the vibration of the bus bar 310 and can suppress occurrence of abnormal noise caused by the vibration of the bus bar 310. Further, in the electrical connection box 4, when the relay terminal fitting 30 absorbs and damps the vibration accompanying the driving of the relay component 20, it is possible to suppress the propagation of the vibration to the bus bar base portion 11, so that it is possible to further suppress the occurrence of abnormal noise caused by the vibration of the bus bar 310. On the other hand, in the electrical connection box 4, the fixing structure 370 is provided at an appropriate position, so that it is possible to suppress the vibration of the bus bar 310 and the occurrence of abnormal noise caused by the vibration even when the relay terminal fitting 30 amplifies the vibration accompanying the driving of the relay component 20.

Furthermore, since the electrical connection box 4 of the present modified example can suppress the vibration of the bus bar 310, it is also possible to suppress abrasion of a contact point between the bus bar terminal connection portion 12A and the relay terminal fitting 30.

### Fourth Modified Example

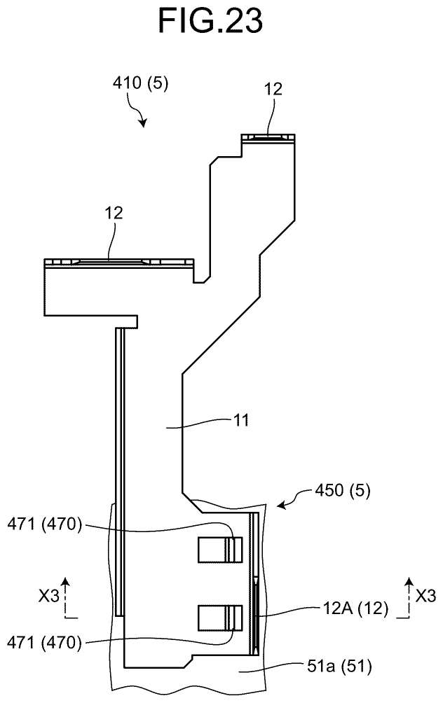

One modified example of the electrical connection box according to the present invention will be described with reference to FIGS. 23 to 27.

In an electrical connection box 5 of the present modified example, the bus bar 10 and the case member 50 of the housing 40 in the electrical connection box 1 of the embodiment described above are replaced with a bus bar 410 and a case member 450 described below, and the fixing structure 70 of the embodiment provided between the bus bar 10 and the case member 50 is changed to a fixing structure 470 described below (FIGS. 23 to 26). Therefore, in the following description, parts and the like equivalent to those illustrated in the embodiment are denoted by the same reference numerals as those in the embodiment, and a description thereof is omitted.

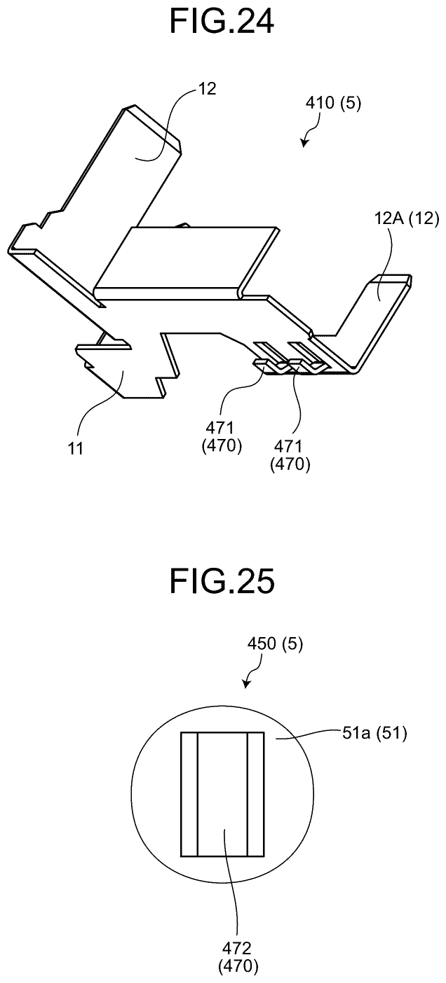

The bus bar 410 of the present modified example includes a bus bar base portion 11 and a bus bar terminal connection portion 12 similarly to the bus bar 10 of the embodiment (FIGS. 23 and 24), and electrically connects a relay component 20 to a bus bar terminal connection portion 12A of the plurality of bus bar terminal connection portions 12 via a relay terminal fitting 30. On the other hand, in the bus bar 410 of the present modified example, a hook portion 471 described below is provided in the bus bar base portion 11 instead of the press-fitting portion 71 provided in the bus bar base portion 11 of the bus bar 10 of the embodiment (FIGS. 23, 24, and 26).

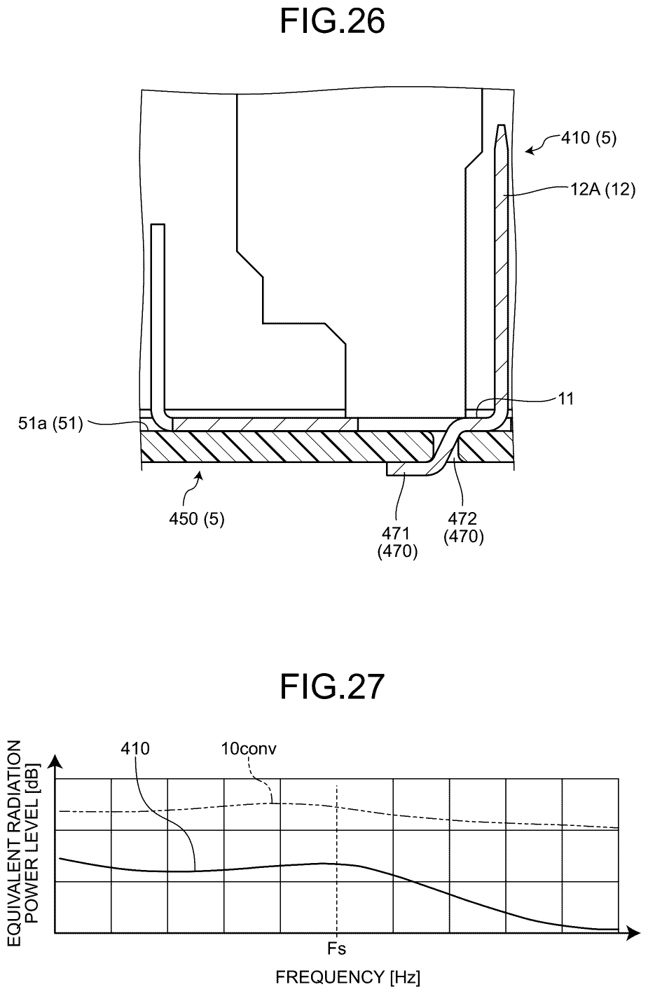

The case member 450 of the present modified example includes a bus bar housing chamber 51 similarly to the case member 50 of the embodiment (FIGS. 23, 25, and 26), and the bus bar 410 and the relay terminal fitting 30 are housed in the bus bar housing chamber 51. Meanwhile, in the case member 450 of the present modified example, an insertion-through hole 472 described below is provided in a bottom wall 51a instead of the press-fitting hole 72 provided in the bottom wall 51a of the bus bar housing chamber 51 in the case member 50 of the embodiment (FIGS. 25 and 26).

The fixing structure 470 of the present modified example includes the cantilevered hook portion 471 protruding from the bus bar base portion 11 in a crank shape, and the insertion-through hole 472 which is a through-hole provided in a flat plate portion (here, the bottom wall 51a) of the case member 450 and through which the hook portion 471 is inserted to be hooked to a hole peripheral edge (FIGS. 23 to 26). The fixing structure 470 is a hook holding structure in which a force is applied to one flat surface of the flat plate portion (the bottom wall 51a) from a free end of the hook portion 471 inserted through the insertion-through hole 472, and a force is applied to the other flat surface of the flat plate portion (the bottom wall 51a) from a fixed end of the hook portion 471 to hook and hold the hook portion 471 to the hole peripheral edge of the insertion-through hole 472 (FIG. 26). In the electrical connection box 5, when vibration accompanying driving of the relay component 20 is propagated to the bus bar base portion 11 via the bus bar terminal connection portion 12A, the vibration is damped until the vibration is transmitted to the fixing structure 470, and the vibration of the bus bar 410 can be suppressed.

The hook portion 471 is formed in a crank-like cantilever shape bent toward the bottom wall 51a in a direction intersecting a flat surface of the bus bar base portion 11 at a middle portion in a protruding direction thereof, and bent again at a distal end (FIGS. 24 and 26). The hook portion 471 illustrated here is formed in a piece shape. The insertion-through hole 472 is formed as a through-hole penetrating through the bottom wall 51a (FIGS. 25 and 26). The insertion-through hole 472 illustrated here is formed as a rectangular through-hole (FIG. 25). The hook portion 471 is inserted into the insertion-through hole 472 from the distal end. As a result, the inserted hook portion 471 applies a force to one flat surface of the bottom wall 51a from the free end, and applies a force to the other flat surface of the bottom wall 51a from the fixed end, and is hooked and fixed to the hole peripheral edge of the insertion-through hole 472.

Similarly to the fixing structure 70 of the embodiment, a position where the fixing structure 470 is disposed is determined based on a simulation analysis result indicating the equivalent radiation power level of the bus bar 10conv according to the related art in which the fixing structure 470 is not provided and the relay component 20 is assembled to the bus bar terminal connection portion 12A via the relay terminal fitting 30 (a line with alternating long and two short dashes in FIG. 27). Therefore, in the electrical connection box 5 of the present modified example, the fixing structure 470 is disposed in the vicinity of the bus bar terminal connection portion 12A (that is, the vicinity of a vibration input portion of the relay component 20 in the bus bar base portion 11) in the bus bar base portion 11.

In this example, the fixing structure 470 is provided at each of two positions between the bus bar base portion 11 and the case member 150, and the vibration of the bus bar base portion 11 is suppressed at each place where the fixing structure 470 is provided. A solid line in FIG. 27 indicates an equivalent radiation power level of the bus bar 410 in the electrical connection box 5 in which the fixing structure 470 is provided. The equivalent radiation power level of the bus bar 410 at the specific frequency Fs can be lower than that of the bus bar 10conv according to the related art to which the fixing structure 470 is not applied.

As described above, the electrical connection box 5 of the present modified example can damp the vibration accompanying the driving of the relay component 20 propagated to the bus bar base portion 11 via the bus bar terminal connection portion 12A by fixing the bus bar base portion 11 and the case member 450 using the fixing structure 470 provided between the bus bar base portion 11 and the case member 450. Therefore, the electrical connection box 5 can suppress the vibration of the bus bar 410 and can suppress occurrence of abnormal noise caused by the vibration of the bus bar 410. Further, in the electrical connection box 5, when the relay terminal fitting 30 absorbs and damps the vibration accompanying the driving of the relay component 20, it is possible to suppress the propagation of the vibration to the bus bar base portion 11, so that it is possible to further suppress the occurrence of abnormal noise caused by the vibration of the bus bar 410. On the other hand, in the electrical connection box 5, the fixing structure 470 is provided at an appropriate position, so that it is possible to suppress the vibration of the bus bar 410 and the occurrence of abnormal noise caused by the vibration even when the relay terminal fitting 30 amplifies the vibration accompanying the driving of the relay component 20.

Furthermore, since the electrical connection box 5 of the present modified example can suppress the vibration of the bus bar 410, it is also possible to suppress abrasion of a contact point between the bus bar terminal connection portion 12A and the relay terminal fitting 30.

The electrical connection box according to the present embodiment can damp the vibration accompanying the driving of the relay component propagated to the bus bar base portion via the bus bar terminal connection portion by fixing the bus bar base portion and the case member using the fixing structure provided between the bus bar base portion and the case member. Therefore, the electrical connection box can suppress the vibration of the bus bar and can suppress occurrence of abnormal noise caused by the vibration of the bus bar.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An electrical connection box comprising:
a bus bar that includes a bus bar base portion having a flat plate shape and a bus bar terminal connection portion having a male tab shape erected from the bus bar base portion;
a relay component in which a relay terminal connection portion is provided;
a relay terminal fitting that physically and electrically connects the bus bar terminal connection portion and physically and electrically connects the relay terminal connection portion; and
a housing that houses the bus bar, the relay component, and the relay terminal fitting, wherein
the housing includes a case member in which a bus bar housing chamber that houses the bus bar is formed, and a cover member that covers the bus bar and the case member, and
a fixing structure that suppresses vibration of the bus bar base portion when vibration accompanying driving of the relay component is propagated to the bus bar base portion via the bus bar terminal connection portion is provided at least at one position between the bus bar base portion and the case member by inserting one of the bus bar base portion and the case member into the other and fixing the bus bar base portion and the case member to each other.

2. The electrical connection box according to claim 1, wherein
the fixing structure is a press-fitting structure including a press-fitting portion erected from the bus bar base portion in a plate thickness direction of the bus bar base portion and a press-fitting hole provided in a bottom wall of the bus bar housing chamber in the case member and into which the press-fitting portion is inserted, press-fitted, and fixed.

3. The electrical connection box according to claim 1, wherein
the fixing structure is a riveting structure including a rivet hole having a through-hole shape and provided in the bus bar base portion, and a rivet portion that protrudes from a bottom wall of the bus bar housing chamber in the case member so as to be inserted through the rivet hole, and fixes the bus bar base portion to the case member at a plastically deformed end portion.

4. The electrical connection box according to claim 1, wherein
the fixing structure is a slide press-fitting structure including a press-fitting portion protruding from the bus bar base portion along a flat surface of the bus bar base portion, and a press-fitting hole provided in the case member and into which the press-fitting portion is slidably inserted in a protruding direction of the press-fitting portion to be press-fitted and fixed.

5. The electrical connection box according to claim 1, wherein
the fixing structure is a spring holding structure including a flexible spring insertion portion that protrudes from the bus bar base portion, and an insertion hole that is provided in the case member and holds the spring insertion portion by an inner peripheral wall receiving a spring force from the inserted spring insertion portion after bending deformation.

6. The electrical connection box according to claim 1, wherein
the fixing structure is a hook holding structure which includes a cantilevered hook portion protruding from the bus bar base portion in a crank shape, and an insertion-through hole which is a through-hole provided in a flat plate portion of the case member and through which the hook portion is inserted to be hooked to a hole peripheral edge, and in which a force is applied to one flat surface of the flat plate portion from a free end of the hook portion inserted through the insertion-through hole, and a force is applied to the other flat surface of the flat plate portion from a fixed end of the hook portion to hook and hold the hook portion to the hole peripheral edge of the insertion-through hole.

7. The electrical connection box according to claim 1, wherein
the bus bar terminal connection portion is physically and electrically connected to the relay terminal fitting by a spring force of the relay terminal fitting applied to a flat surface of the bus bar terminal connection portion.

8. The electrical connection box according to claim 2, wherein
the bus bar terminal connection portion is physically and electrically connected to the relay terminal fitting by a spring force of the relay terminal fitting applied to a flat surface of the bus bar terminal connection portion.

9. The electrical connection box according to claim 3, wherein
the bus bar terminal connection portion is physically and electrically connected to the relay terminal fitting by a spring force of the relay terminal fitting applied to a flat surface of the bus bar terminal connection portion.

10. The electrical connection box according to claim 4, wherein
the bus bar terminal connection portion is physically and electrically connected to the relay terminal fitting by a spring force of the relay terminal fitting applied to a flat surface of the bus bar terminal connection portion.

11. The electrical connection box according to claim 5, wherein
the bus bar terminal connection portion is physically and electrically connected to the relay terminal fitting by a spring force of the relay terminal fitting applied to a flat surface of the bus bar terminal connection portion.

12. The electrical connection box according to claim 6, wherein
the bus bar terminal connection portion is physically and electrically connected to the relay terminal fitting by a spring force of the relay terminal fitting applied to a flat surface of the bus bar terminal connection portion.
